(19) United States
(12) Patent Application Publication
(10) Pub. No.: US 2020/0164692 A1
(43) Pub. Date: May 28, 2020

(54) PNEUMATIC TIRE

(71) Applicant: TOYO TIRE CORPORATION, Itami-shi (JP)

(72) Inventor: Kazuki Ohta, Itami-shi (JP)

(73) Assignee: TOYO TIRE CORPORATION, Itami-shi (JP)

(21) Appl. No.: 16/695,594

(22) Filed: Nov. 26, 2019

(30) Foreign Application Priority Data
Nov. 28, 2018 (JP) 2018-222225

(51) Int. Cl. B60C 11/00; B60C 3/04

(52) U.S. Cl. CPC B60C 11/0083; B60C 2011/0016; B60C 3/04

(57) ABSTRACT

A pneumatic tire includes a tread portion 1 that has an outer surface shaped such that the following expression is satisfied in a no-load state where no internal pressure is applied,

0.95×Rs<Rc<1.05×Rs
wherein Rc is a radius of curvature of a center-side outer surface in a tire meridian cross section, and Rs is a radius of curvature of a shoulder-side outer surface in the tire meridian cross section.

### CROSS-REFERENCE TO RELATED APPLICATIONS

This application claims priority of Japanese Patent Application No.:2018-222225 filed on Nov. 28, 2018, the content of which is incorporated herein by reference.

### BACKGROUND OF THE INVENTION

### Technical Field

The present invention relates to a pneumatic tire.

### Related Art

A following pneumatic tire is conventionally known.

JP 5-77608 A discloses a pneumatic tire which includes: a pair of narrow grooves in a tread; first arc portions extending between a tread center and the respective narrow grooves; and second arc portions extending between the respective narrow grooves and respective tread ends.

JP 11-129705 A discloses a pneumatic tire which includes a footprint in a tread surface. The footprint includes a ground contact contour line in a tread center region and a ground contact contour line in a tread shoulder region discontinuously crossing each other at a boundary. Not an extension line of the ground contact contour line but the ground contact contour line is located on an outer side in a tire circumferential direction with respect to a ground contact central portion.

JP 2004-203343 A discloses a pneumatic tire which includes: an outer longitudinal groove formed between a shoulder block and an inner block and inclined to a tire circumferential direction; and an outer longitudinal groove deflection region that is a tire axial region extending between both ends of the outer longitudinal groove in the tire circumferential direction.

However, none of the pneumatic tires described above gives sufficient consideration to reduction of uneven wear.

An object of the present invention is to provide a pneumatic tire capable of reducing uneven wear of a ground contact surface.

### SUMMARY

As a means for achieving the aforementioned object, the present invention provides a pneumatic tire including a tread portion shaped so as to satisfy the following expression in a no-load state where no internal pressure is applied,

0.95×Rs<Rc<1.05×Rs

wherein Rc is a radius of curvature of a center-side outer surface in a tire meridian cross section is, and Rs is a radius of curvature of a shoulder-side outer surface in the tire meridian cross section.

This configuration reduces a large difference in ground contact pressure between the center-side outer surface and the shoulder-side outer surface even when the outer surface of the tread portion is constituted by the two curved surfaces having different radii of curvature in the tire meridian cross section. Accordingly, this configuration prevents excessive wear on the center-side outer surface in comparison with the shoulder-side outer surface, and therefore reduces uneven wear.

The tread portion preferably has an edge at each of ends in a tire width direction.

This configuration reduces a considerable drop of the ground contact pressure of the shoulder-side outer surface in comparison with the ground contact pressure of the center-side outer surface.

The radius of curvature Rc of the center-side outer surface is preferably determined such as to satisfy 680 mm<Rc<880 mm.

The radius of curvature Rs of the shoulder-side outer surface is preferably determined such that the following expression is satisfied,

600 mm<Rs<1000 mm.

A boundary position between the center-side outer surface and the shoulder-side outer surface is preferably a position shifted by ¼ of a width dimension of the tread portion from each end of the tread portion.

The pneumatic tire is suitable for use as a rear wheel of a rear wheel drive vehicle.

According to the present invention, distribution of the ground contact pressure is equalized with reduction of wear at a center portion. Accordingly, uneven wear is avoidable as viewed from an entire ground contact surface.

### BRIEF DESCRIPTION OF THE DRAWINGS

The foregoing and the other features of the present invention will become apparent from the following description and drawings of an illustrative embodiment of the invention in which:

FIG. 1 is a meridian half cross-sectional view of a pneumatic tire according to a present embodiment.

### DETAILED DESCRIPTION OF EMBODIMENTS

An embodiment according to the present invention will be hereinafter described with reference to the accompanying drawings. It should be noted that the following description is essentially presented by way of example, and not intended to limit the present invention, applicable ranges of the present invention, or purposes of use of the present invention. The respective drawings are only schematic illustrations, and ratios of respective dimensions and the like do not necessarily indicate actual ones.

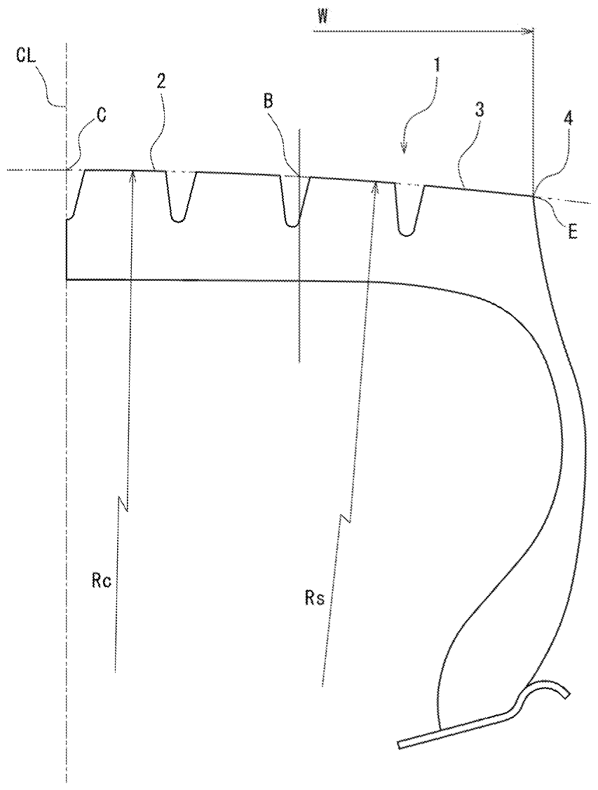

FIG. 1 is a meridian half cross-sectional view of a pneumatic tire according to the present embodiment. An outer surface of a tread portion 1 of the pneumatic tire has an arc shape in a meridian cross section. More specifically, the outer surface shape of the tread portion 1 is constituted by a center-side outer surface 2 and a shoulder-side outer surface 3 having different radii of curvature. Each end of the tread portion 1 in a tire width direction forms an edge 4 to constitute what is called a square tire. A tire width dimension W will hereinafter indicate a distance between the edges 4 on both sides.

The center-side outer surface 2 and the shoulder-side outer surface 3 are designed such that the following expression is satisfied,

0.95×Rs<Rc<1.05×Rs

wherein Rc is a radius of curvature of the center-side outer surface 2, and Rs is a radius of curvature of the shoulder-side outer surface 3.

When “Rc≤0.95×Rs” is satisfied, the ground contact pressure of the shoulder-side outer surface 3 is much higher than the ground contact pressure of the center-side outer surface 2. Specifically, the following expression is satisfied,

P2<P3

wherein P2 is a ground contact pressure of the center-side outer surface 2 per unit area, and P3 is a ground contact pressure of the shoulder-side outer surface 3 per unit area.

When “1.05×Rs≤Rc” is satisfied, the ground contact pressure of the shoulder-side outer surface 3 becomes much lower than the ground contact pressure of the center-side outer surface 2 (P2>P3).

In these cases, uneven wear may be produced by variations of the ground contact pressure in the tire width direction.

The radius of curvature Rc of the center-side outer surface 2 is determined such that the following expression is satisfied,

680 mm<Rc<880 mm.

The radius of curvature Rc is set to 780 mm in the present embodiment.

When “Rc≤680 mm” is satisfied, the ground contact pressure of the shoulder-side outer surface 3 is much higher than the ground contact pressure of the center-side outer surface 2 (P2<P3).

When “880 mm≤Rc” is satisfied, the ground contact pressure of the shoulder-side outer surface 3 is much lower than the ground contact pressure of the center-side outer surface 2 (P2>P3).

In these cases, uneven wear may be produced by variations of the ground contact pressure in the tire width direction.

The radius of curvature Rs of the shoulder-side outer surface 3 is determined such that the following expression is satisfied,

600 mm<Rs<1000 mm

The radius of curvature Rs is set to 800 mm in the present embodiment.

When “Rs≤600 mm” is satisfied, the ground contact pressure of the shoulder-side outer surface 3 is much lower than the ground contact pressure of the center-side outer surface 2 (P2>P3).

When “1000 mm≤Rs” is satisfied, the ground contact pressure of the shoulder-side outer surface 3 is much higher than the ground contact pressure of the center-side outer surface 2 (P2<P3).

In these cases, uneven wear may be produced by variations of the ground contact pressure in the tire width direction.

The center-side outer surface 2 is configured as follows. An outer diameter of the pneumatic tire, which is defined on a center line CL for division into two parts in the tire width direction, is determined in a no-load state where no internal pressure is applied. A center of the radius of curvature Rc of the center-side outer surface 2 is located on the center line CL. The center-side outer surface 2 which extends from the center line CL toward the outer side in the tire width direction has a length of ¼ of the tire width dimension W. The radius of curvature Rc of the center-side outer surface 2 is 780 mm.

The shoulder-side outer surface 3 is configured as follows. Each position of the edges 4 of the tread portion 1 (edge position E) is determined in a no-load state where no internal pressure is applied. Suppose an arc which has a radius of curvature R and passes through a center position C (determined by tire outer diameter) with a center of the arc located on the center line CL. The edge position E is a position at which the arc reaches the tire width dimension. The radius of curvature R is a design target value, which is set to 1217 mm in the present embodiment. As described above, a connection position between shoulder-side outer surface 3 and the center-side outer surface 2 is determined by the length of ¼ of the tire width dimension W (boundary position B). A center of the radius of curvature Rs of the shoulder-side outer surface 3 is located on a perpendicular bisector of a line segment connecting the edge position E and the boundary position B. The radius of curvature Rs of the shoulder-side outer surface 3 is 800 mm.

The pneumatic tire which includes the tread portion 1 having the outer surface shape determined as described above is used as a rear wheel of a rear wheel drive vehicle. A rear wheel of a rear wheel drive vehicle does not perform turning in a normal use condition, and a center region of the rear wheel is easily worn.

However, the tread portion 1 of the pneumatic tire according to the present embodiment is recessed at the boundary position B located at the position corresponding to a length of ¼ of the tire width dimension W from the center position C (feature 1: position not easily recognizable from FIG. 1 but actually recessed) as described above.

When the boundary position B is located on the center side with respect to the position corresponding to the length of ¼ of the tire width dimension W from the center position C, a ground contact length on the shoulder side becomes larger than a ground contact length on the center side. In this case, a ground contact pressure per unit area on the center side becomes higher than a ground contact pressure on the shoulder side. Accordingly, a wear volume on the center side becomes larger than a wear volume on the shoulder side. On the contrary, when the boundary position B is located on the shoulder side with respect to the position corresponding to the length of ¼ of the tire width dimension W from the center position C, the ground contact length on the center side becomes larger than the ground contact length on the shoulder side. In this case, the ground contact pressure per unit area on the shoulder side becomes higher than the ground contact pressure on the center side. Accordingly, the wear volume on the shoulder side becomes larger than the wear volume on the center side.

As described above, the center-side outer surface 2 and the shoulder-side outer surface 3 of the tread portion 1 are configured such as to satisfy “0.95×Rs<Rc<1.05×Rs” (feature 2).

According to the pneumatic tire which includes the tread portion 1 having the features 1 and 2 described above, the ground contact pressure per unit area on the center side is equalized with the ground contact pressure per unit area on the shoulder side. Accordingly, equalization of the wear volume is achievable without producing uneven wear of the ground contact surface.

What is claimed is:

1. A pneumatic tire comprising a tread portion that has an outer surface shaped so as to satisfy the following expression in a no-load state where no internal pressure is applied,
0.95×Rs<Rc<1.05×Rs
wherein Rc is a radius of curvature of a center-side outer surface in a tire meridian cross section is, and Rs is a radius of curvature of a shoulder-side outer surface in the tire meridian cross section.

2. The pneumatic tire according to claim 1, wherein the tread portion has an edge at each of ends in a tire width direction.

3. The pneumatic tire according to claim 1, wherein the radius of curvature Rc of the center-side outer surface is determined such that the following expression is satisfied,
680 mm<Rc<880 mm.

4. The pneumatic tire according to claim 2, wherein the radius of curvature Rc of the center-side outer surface is determined such that the following equation is satisfied,
680 mm<Rc<880 mm.

5. The pneumatic tire according to claim 1, wherein the radius of curvature Rs of the shoulder-side outer surface is determined such that the following expression is satisfied,
600 mm<Rs<1000 mm.

6. The pneumatic tire according to claim 2, wherein the radius of curvature Rs of the shoulder-side outer surface is determined such that the following expression is satisfied,
600 mm<Rs<1000 mm.

7. The pneumatic tire according to claim 3, wherein the radius of curvature Rs of the shoulder-side outer surface is determined such that the following expression is satisfied,
600 mm<Rs<1000 mm.

8. The pneumatic tire according to claim 4, wherein the radius of curvature Rs of the shoulder-side outer surface is determined such that the following expression is satisfied,
600 mm<Rs<1000 mm.

9. The pneumatic tire according to claim 1, wherein a boundary position between the center-side outer surface and the shoulder-side outer surface is a position shifted by ¼ of a width dimension of the tread portion from each end of the tread portion.

10. The pneumatic tire according to claim 2, wherein a boundary position between the center-side outer surface and the shoulder-side outer surface is a position shifted by ¼ of a width dimension of the tread portion from each end of the tread portion.

11. The pneumatic tire according to claim 3, wherein a boundary position between the center-side outer surface and the shoulder-side outer surface is a position shifted by ¼ of a width dimension of the tread portion from each end of the tread portion.

12. The pneumatic tire according to claim 4, wherein a boundary position between the center-side outer surface and the shoulder-side outer surface is a position shifted by ¼ of a width dimension of the tread portion from each end of the tread portion.

13. The pneumatic tire according to claim 5, wherein a boundary position between the center-side outer surface and the shoulder-side outer surface is a position shifted by ¼ of a width dimension of the tread portion from each end of the tread portion.

14. The pneumatic tire according to claim 6, wherein a boundary position between the center-side outer surface and the shoulder-side outer surface is a position shifted by ¼ of a width dimension of the tread portion from each end of the tread portion.

15. The pneumatic tire according to claim 7, wherein a boundary position between the center-side outer surface and the shoulder-side outer surface is a position shifted by ¼ of a width dimension of the tread portion from each end of the tread portion.

16. The pneumatic tire according to claim 8, wherein a boundary position between the center-side outer surface and the shoulder-side outer surface is a position shifted by ¼ of a width dimension of the tread portion from each end of the tread portion.

17. The pneumatic tire according to claim 1, wherein the pneumatic tire is used as a rear wheel of a rear wheel drive vehicle.

18. The pneumatic tire according to claim 2, wherein the pneumatic tire is used as a rear wheel of a rear wheel drive vehicle.

19. The pneumatic tire according to claim 3, wherein the pneumatic tire is used as a rear wheel of a rear wheel drive vehicle.

20. The pneumatic tire according to claim 4, wherein the pneumatic tire is used as a rear wheel of a rear wheel drive vehicle.
